(19) United States
(12) Patent Application Publication
(10) Pub. No.: US 2008/0149303 A1
(43) Pub. Date: Jun. 26, 2008

(54) HEAT SINK FOR A SHAFT-TYPE LINEAR MOTOR

(76) Inventors: CHIA-MING CHANG, Taichung (TW); Fang-Fang Tai, Taichung (TW); Lieh-Feng Huang, Taichung (TW)

Correspondence Address: Dr. BANGER SHIA, 102 Lindencrest Ct., Sugar Land, TX, 77479-5201, US

(21) Appl. No.: 11/616,011

(22) Filed: Dec. 25, 2006

(51) Int. Cl. H02K 9/26; F28D 15/00

(52) U.S. Cl. 165/80.2; 310/12; 165/104.11; 310/52

(57) ABSTRACT

A heat sink for a shaft-type linear motor is detachably positioned on a mover and is interiorly defined with a space. A plurality of coolant-receiving channels is formed in a wall between the space and an outer surface of the heat sink, and each of the coolant-receiving channels includes at least one inlet and one outlet. A plurality of concave and convex radiation fins is formed on an outer surface of the mover. Such an arrangement is suitable for modular production, so as to facilitate replacement and design of the product. Further, the radiation fins cooperate with the liquid cooling effect to enable the motor to produce the maximum pushing force.

### BACKGROUND OF THE INVENTION

1. Field of the Invention

The present invention relates to a component of a shaft-type linear motor, and more particularly to a heat sink for a shaft-type linear motor, which can carry away heat and is suitable for modular production, thus facilitating replacement and design of the product. Further, the radiation fins cooperate with the liquid cooling effect to enable the motor to produce the maximum pushing force.

2. Description of the Prior Art

Nowadays, shaft-type linear motor is used more and more widely in modern industries, and the linear transmission device generally includes linear guideway and ball screw. In addition to the effect of high precision, the linear transmission device also has the advantages of low frictional loss, high energy conversion ratio, low noise and high rigidity. Hence, it is self-evident that the shaft-type linear motor is very important to various industrial mechanisms.

In order that the stator and the mover can operate smoothly, the current shaft-type linear motors are usually provided on the elongated stator thereof with different magnetic poles (the stator is in the form of a shaft), and then a mover with coils is mounted on the elongated stator, and the coils are used to move the mover along the stator based on the theory of the generation of magnetic force by electric power. However, the various existing designs have their own disadvantages. Therefore, how to develop an improved and competitive tape-sticking product is the common goal that the manufactures are striving for.

Examples of various conventional shaft-type axis motors are as shown in FIGS. 1 and 2.

FIG. 1 shows a conventional structure disclosed in U.S. Pat. No. 6,313,552, wherein a mover 10 with coils 11 is mounted an elongated stator (not shown) and moves along the rail 12. The coils 11 drive the mover 10 to move based on the theory of the generation of magnetic force by electric power. A plurality of concave and convex radiation fins 13 is formed on the surface of the mover 10 and serves to carry away heat from the coils 11 generated during the generation of magnetic force by electric power, thus preventing the heat from affecting the mover's operation. However, the disadvantage of this design is that:

Since the radiation fins 13 serve to carry away heat from the coils 11 only, the release of heat still relies on the air transmission to cool down the radiation fins 13 slowly. The heat-radiating effect of this conventional design is poor, and is unable to effectively bring the effect of the mover's motion into full play.

FIG. 2 shows a conventional structure disclosed in JP Pat. No. 11-206099, wherein a mover 15 with coils 14 is mounted an elongated stator 16 and moves along the stator 16. The coils 14 drive the mover 15 to move based on the theory of the generation of magnetic force by electric power. The mover 15 is covered with an air cover 17, and in the air cover 17 is a tube 172 connected to a fan 171.The air cover 17 is further formed with a plurality of discharge holes 173 located opposite the tube 172. The wind 171 produced by the fan 171 takes away heat from the coils 14 generated during the course of generation of magnetic force by the electric power, and the hot air is expelled out of the discharge holes 173. However, the disadvantage of this design is that:

First, the effect of heat conduction of the coils 11 by air is poor, therefore, the heat radiation effect of this conventional technique still needs to be improved, and is unable to effectively bring the effect of the mover's motion into full play.

Second, the connection and the arrangements of the air cover 17, the tube 172, and the fan 171 are complicated and difficult, and are unsuitable for modular design or production.

Third, the hot air expelled out of the discharge holes 173 will adversely affect the working surrounding, and probably result in noise and dust.

To effectively solve the aforementioned problems, the inventor of the present invention, on the basis of the accumulated experience and skills associated with the linear transmission field, has developed a brand new shaft-type linear motor.

### SUMMARY OF THE INVENTION

The primary objective of the present invention is to provide a heat sink for a shaft-type linear motor with improved cooling effect and optimal performance.

The secondary objective of the present invention is to provide a heat sink for a shaft-type linear motor suitable for modular design.

To obtain the aforementioned objective, a heat sink for a shaft-type linear motor in accordance with the present invention is detachably positioned on a mover and is interiorly defined with a space. A plurality of coolant-receiving channels is formed in a wall between the space and an outer surface of the heat sink, and each of the coolant-receiving channels includes at least one inlet and one outlet. A plurality of concave and convex radiation fins is formed on an outer surface of the mover.

The heat sink is suitable for modular production, and a mover can be used with different heat sinks, so as to facilitate replacement and design of the product.

Further, the radiation fins cooperate with the liquid cooling effect to enable the motor to produce the maximum pushing force.

### BRIEF DESCRIPTION OF THE DRAWINGS

FIG. 1 is an illustrative view of showing a conventional heat sink for a shaft-type linear motor disclosed in U.S. Pat. No. 6,313,552;

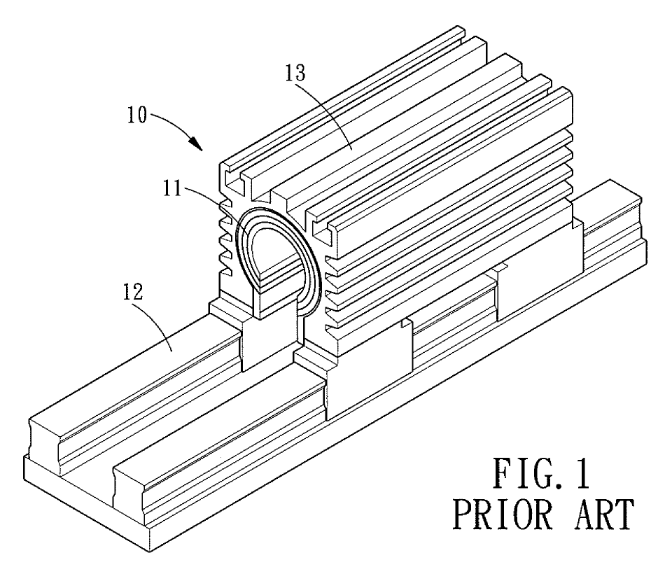

FIG. 2 is an illustrative view of showing a conventional heat sink for a shaft-type linear motor disclosed in JP Pat. No. 11-206099;

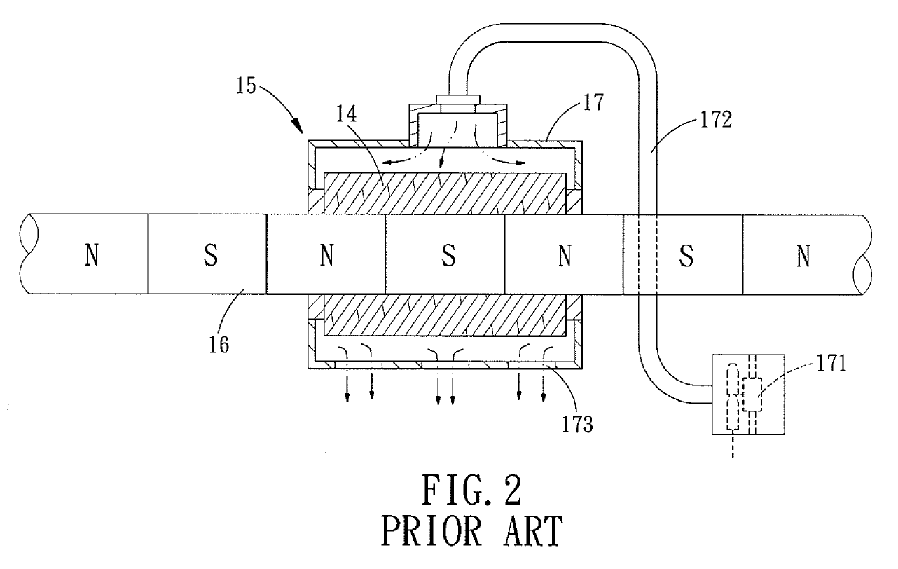

FIG. 3 is a stereographic view of a heat sink for a shaft-type linear motor in accordance with the present invention;

FIG. 4 is a cross sectional view in accordance with the present invention of showing the coolant-receiving channels formed in the heat sink; and

FIG. 5 is an illustrative view in accordance with the present invention of showing that the heat sink is assembled on a mover.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

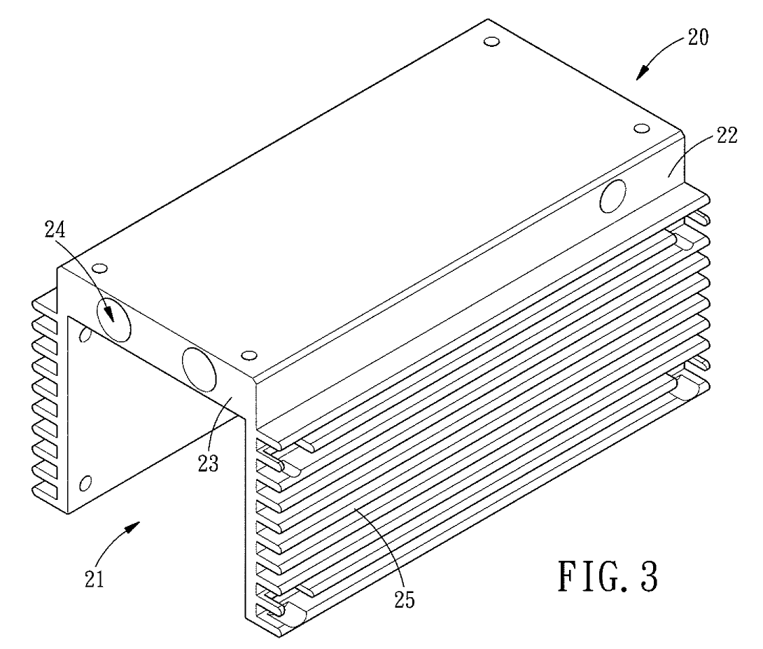

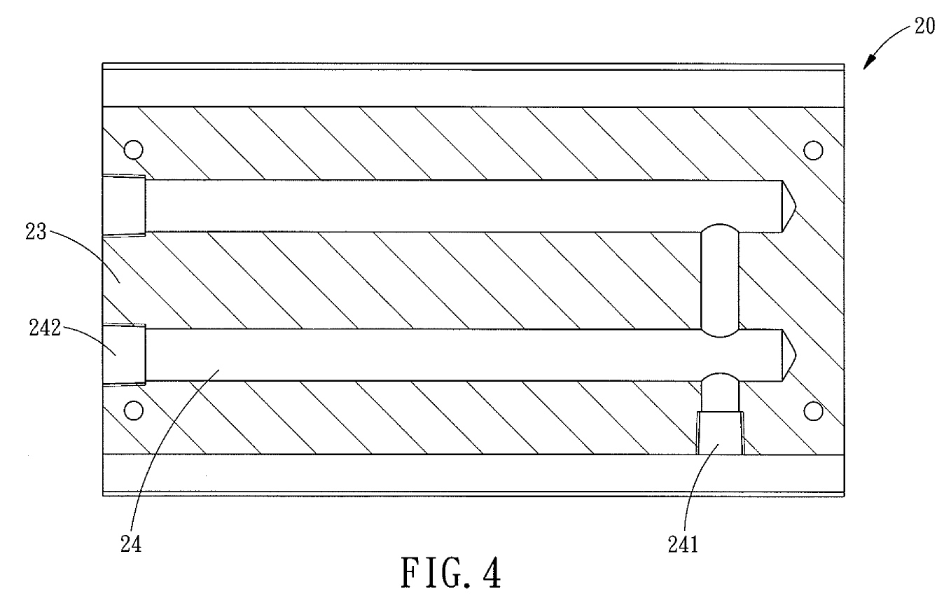

Referring to FIGS. 3-5, a heat sink 20 for a shaft-type linear motor in accordance with a first embodiment of the present invention is positioned on a mover 30 with coils, and is characterized in that:

The heat sink 20 is detachably positioned on the mover 30 and is interiorly defined with a space 21 formed correspondingly to the shape of the mover 30 and is provided for accommodation of the mover 30, and the heat sink 20 and the mover 30 are fixed by screws. A plurality of coolant-receiving channels 24 is formed in the wall 23 between the space 21 and the outer surface 22 of the heat sink 20. Each of the coolant-receiving channels 24 includes an inlet 241 and an outlet 242 that are connected to each other by a tube, so that the pressurized coolant liquid keeps flowing within the coolant-receiving channels 24. On the outer surface 22 of the heat sink 20 are formed with a plurality of concave and convex radiation fins 25.

The pressurized coolant liquid can be water, oil, chemical coolant, and etc.

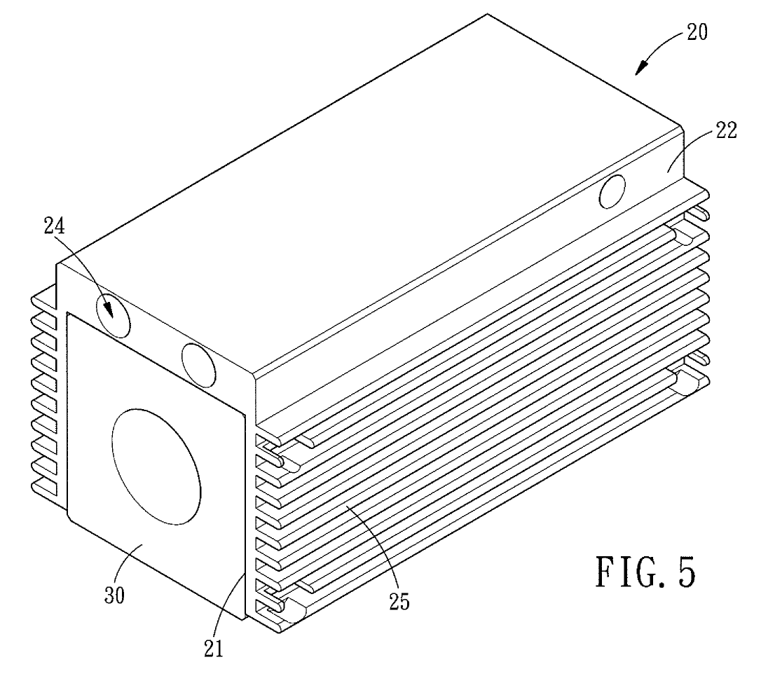

It is to be noted that, as shown in FIG. 5, the space 21 is formed correspondingly to the shape of the mover 30 so as to accommodate the mover 30, and this feature enables the producer to produce the heat sink 20 and the mover 30 easily by using modular design, so that the mover 30 can selectively cooperate with different heat sinks. For example, the mover 30 can be used with the heat sink with coolant-receiving channels only, or with radiation fins only, or with both structures. Or the mover can be used with different heat sinks with different numbers of coolant-receiving channels according to the cooling requirement. Therefore, the present invention is suitable for modular design and facilitates replacement of the heat sink of the shaft-type linear motor.

For a better understanding of the embodiment, reference should be made to the following descriptions.

The heat sink of the present invention is defined with a space, and a plurality of coolant-receiving channels is formed in the wall between the space and the outer surface of the heat sink. Each of the coolant-receiving channels includes an inlet and an outlet that are connected to each other by a tube. On the outer surface of the heat sink is formed with a plurality of concave and convex radiation fins. The radiation fins cooperate with the liquid cooling effect to enable the motor to produce the maximum pushing force. Therefore, the present invention has the following advantages as compared with the prior art:

First, low noise, no dust, therefore, the present invention will not affect the work surrounding.

Second, the present invention is suitable for modular design and production.

Third, the cooling effect of the present invention is better than various conventional designs, and the present invention can improve the performance of the shaft-type linear motor. The operation data of the shaft-type linear motor used with the heat sink of the present invention is shown in the following table:

| | Shaft-type | |
|---|---|---|
| | linear motor | |
| item | STM | remark |
| Force Constant(N/A) | 15.5 | |
| Temperature rise balance current | 2.1 | |
| (100° C./A) | | |
| Water cooling Temperature rise | 3.6 | |
| balance current | | |
| (100° C./A) | | |
| Continuous force(N) | 32.5 | |
| Water cooling Continuous | 55.8 | |
| force(N) | | |

While we have shown and described various embodiments in accordance with the present invention, it is clear to those skilled in the art that further embodiments may be made without departing from the scope of the present invention.

What is claimed is:

1. A heat sink for a shaft-type linear motor being detachably positioned on a mover and interiorly defined with a space, the space formed correspondingly to the shape of the mover and being provided for accommodation of the mover, a plurality of coolant-receiving channels formed in a wall between the space and an outer surface of the heat sink, each of the coolant-receiving channels includes at least one inlet and one outlet, so that pressurized coolant liquid keeps flowing within the coolant-receiving channels.

2. The heat sink for a shaft-type linear motor as claimed in claim 1, wherein a plurality of concave and convex radiation fins is formed on an outer surface of the mover.

3. The heat sink for a shaft-type linear motor as claimed in claim 2, wherein the heat sink is fixed on the mover by screws.

4. The heat sink for a shaft-type linear motor as claimed in claim 1, wherein the coolant liquid is water, cooling oil, or chemical coolant.
